(19) United States
(12) Patent Application Publication
(10) Pub. No.: US 2004/0215831 A1
(43) Pub. Date: Oct. 28, 2004

(54) Method for operating storage system

(75) Inventors: Tomoki Shoji, Fujisawa (JP); Masaharu Murakami, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/424,559

(22) Filed: Apr. 25, 2003

(51) Int. Cl. G06F 15/16; G06F 15/173

(52) U.S. Cl. 709/249; 709/238; 709/219

(57) ABSTRACT

A method for operating a storage system, which includes a plurality of storage networks, a gateway device to which the storage networks are connected, and a server device connected to the gateway device, comprises: providing a management computer that is connected to the server device and that is for getting hold of a usage state of storages connected to the respective storage networks; and changing a path setting of the gateway device in accordance with information notified from the management computer.

### BACKGROUND OF THE INVENTION

1. Field of the Invention

The present invention relates to a method for operating a storage system and, more particularly, to a technology for enabling a storage operator managing a data center or the like to perform storage operation efficiently.

2. Description of the Related Art

A progress in IT technology has brought about a greater demand for a mechanism to efficiently manage enormous data. Recently, a large number of so-called data centers have been managed for business purposes of providing storage areas.

Data centers are used by many customers for various purposes. For this reason, it is extremely difficult to accurately estimate the amount of storage area necessary for the management of the data center. Consequently, a contradicting situation may occur. For example, there may be a data center in which the capacity of necessary storage area has been overestimated and that holds superfluous free space area, resulting in enormous operation costs. On the other hand, there may be a data center which has underestimated the capacity of necessary storage area and is short of free space area, resulting in difficulties in system management such as impossibility of increasing the storage area when it is necessary. It is normal that the data center holding the superfluous free space area would like to use the free space area to make profits, and that the data center which has underestimated the storage area and is suffering from difficulties in system management would like to use a mechanism that would enable quick expansion of storage area when the free space area becomes short.

Therefore, in order to fulfill the needs of both such data centers and also to solve the contradiction, the inventors of the present invention have conceived an idea of providing a mechanism for data centers to mutually rent storage areas through a communication line. In other words, according to the present concept, data centers holding superfluous free area can change the free storage area, which used to be a negative property, into a profitable source by collecting rental fees, and on the other hand, data centers that could not expand their storage area are able to quickly expand their storage area by renting the storage area through the communication line.

### SUMMARY OF THE INVENTION

The present invention is made based on the foregoing concept, and it is an object of the present invention to provide a storage system operating method which enables a storage operator managing a data center or the like to perform storage operation efficiently.

According to a main aspect of the present invention to attain the object, a method for operating a storage system, which includes a plurality of storage networks, a gateway device to which the storage networks are connected, and a server device connected to the gateway device, comprises: providing a management computer that is connected to the server device and that is for getting hold of a usage state of storages connected to the respective storage networks; and changing a path setting of the gateway device in accordance with information notified from the management computer.

### BRIEF DESCRIPTION OF THE DRAWINGS

The present invention and its advantages can be understood more fully upon reading the following detailed description when taken in conjunction with the accompanying drawings, in which:

FIG. 1 is a conceptual diagram showing a storage service system according to an embodiment of the present invention;

FIG. 2 is a flowchart explaining a process carried out on rental application according to the embodiment of the present invention;

FIG. 3 is a diagram showing a rental application screen according to the embodiment of the present invention;

FIG. 4 is a diagram showing a rental permission approval screen according to the embodiment of the present invention;

FIG. 5 is a diagram showing an example of path setting of a gateway device according to the embodiment of the present invention;

FIG. 6 is a flowchart explaining rental application according to another embodiment of the present invention;

FIG. 7 is a diagram showing a rental cancellation application screen according to the embodiment of the present invention;

FIG. 8 is a flowchart explaining a rental cancellation process according to the embodiment of the present invention; and

FIG. 9 is a diagram showing a rental cancellation notification screen according to the embodiment of the present invention.

### DETAILED DESCRIPTION OF THE PREFERRED EMBODIMENTS

At least the following will become apparent by the description of the specification and the accompanying drawings.

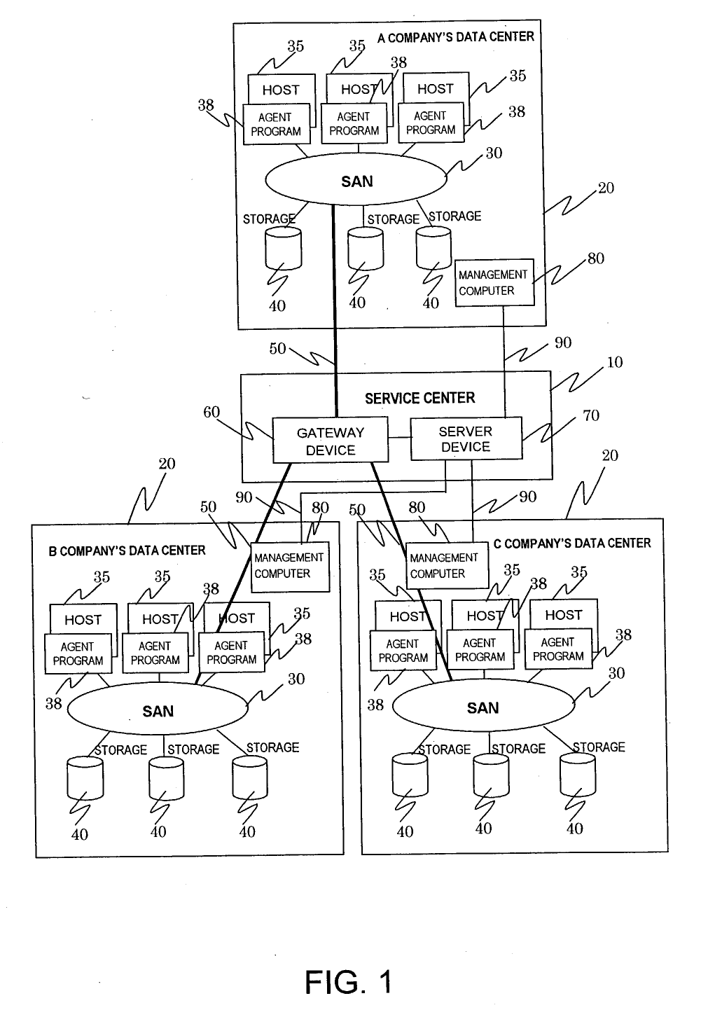

FIG. 1 is a conceptual diagram showing a storage service system, which is described as an embodiment of the present invention. In the figure, a service center 10 is managed by a service trader which sells and rents storage to providers A, B and C. Data centers 20 are managed by the providers A, B and C.

In each data center 20, a storage area network (SAN) 30 is configured. Host computers 35 (referred to as “hosts” hereinafter) used for various purposes such as web server management and a database system, and storages 40 that are storage resources for the hosts 35 are connected to each of the SANs 30. In the embodiment, the storage 40 is assumed to be, for example, a disk array device. However, the storage 40 is not limited to such a device.

In the service center 10 the following devices are operated: a gateway device 60 which is connected to the SANs 30 by appropriate communication means 50 such as a private line, the Internet or a public communication network; and a server device 70 which is connected to the gateway device 60 and is provided with a function for setting paths of the gateway device 60 using a zoning function, an LU masking function or the like. The gateway device 60 in the present embodiment is a Fibre Channel switch. In the server device 70, various software applications are operated to carry out various processes such as state management and history management of usage of the storages 40 provided by the service trader, and billing management of rented storages 40.

A management computer 80 is provided in each of the data centers 20. The management computer 80 is connected to the storages 40 through a communication line (not shown), which may be, for example, an IP network or based on simple network management protocol (SNMP) or SCSI, to get hold of the usage state, such as remaining capacity, of the storages 40. The management computer 80 is also connected to the server device 70 through appropriate communication means 90 such as a private line or the Internet.

The service trader provides services so that a storage area supplied from the unused storage 40 in a certain data center 20 can be rented out to another data center 20. Rental can be carried out according to various units: per storage 40; per physical device, such as a disk unit mounted on a disk array device; per predetermined area of the physical device; or per logical device, which is defined among a plurality of physical devices.

In the server device 70, a storage database used for performing such services is operated. In the storage database is registered information about the storages 40 supplied by the service trader to the data centers 20. The information may include: IDs of the data centers 20 in which the storages 40 are provided, the IDs being registered in association with the IDs of those storages; IDS of the providers which manage the data centers 20; and information about performance, such as total capacity and reading/writing speed of the storages 40.

[Rental Application]

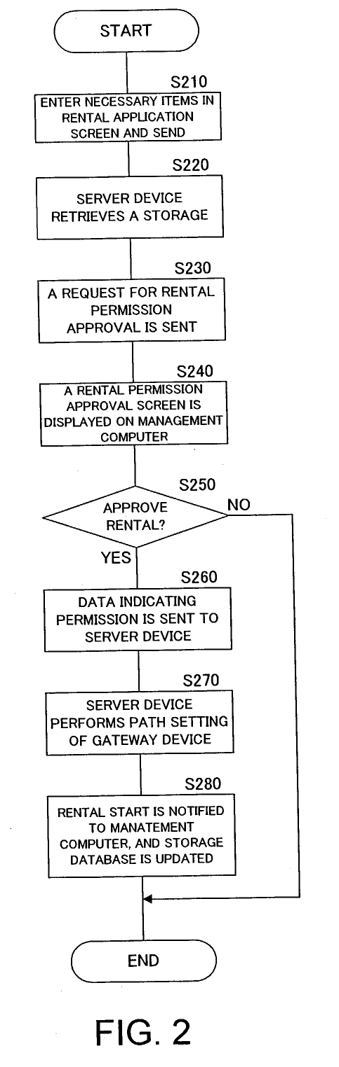

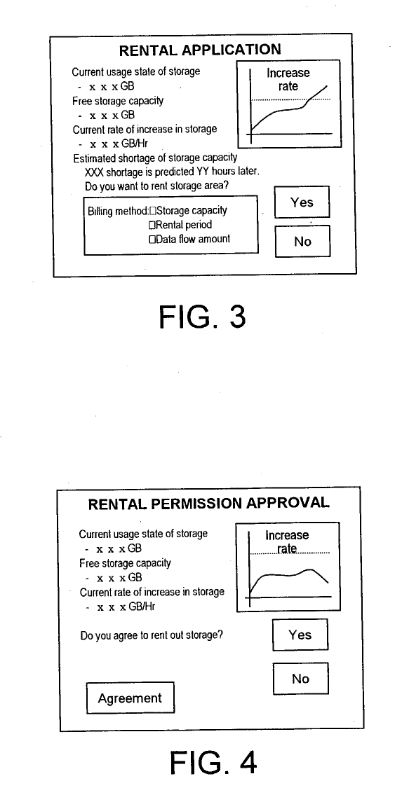

Now, a process carried out on rental application will be described with reference to the flowchart of FIG. 2. As shown in the flowchart, an operator of a data center 20 operates a management computer 80 to carry out the rental application. FIG. 3 shows a rental application screen which is shown on the display of the management computer 80 when the operator performs application. With reference to the screen, the operator studies the usage state, such as a remaining capacity, of a storage 40 owned or rented by a provider, and decides whether or not to carry out the rental application.

If the operator decides to apply for rental, the operator specifies, for example, a size of a storage area to be rented, a desired period of use, or a billing method on the screen shown in FIG. 3 and then presses the “YES” button thereon. Then, communication data indicating a request for the rental application and the specified information is sent from the management computer 80 to the server device 70 through the communication means 90 (S210). The communication data contains additional information such as a user ID given to each provider or information about the billing method.

Receiving the communication data, the server device 70 retrieves a storage 40 which matches the conditions (specifications) specified in the communication data, such as the size of the storage area to be rented and the desired period of use, from a storage database (S220). In this retrieval, a plurality of storages that match the condition may be retrieved. In such a case, selection of a storage 40 can be carried out, for example, by selecting a specific storage 40 automatically in accordance with selection conditions preset by the provider, such as inexpensive use fees, a fast operation speed, and a long-term availability, or by sending a screen urging the operator to select a storage from the server device 70 to the management computer 80 to make the operator select a storage 40.

Next, the server device 70 transmits an ID of the retrieved storage and communication data for requesting rental permission approval of that storage to a management computer 80 of a data center 20 that has the retrieved storage 40 through the communication means 90 (S230). When the communication data arrives, the management computer 80 displays a rental permission approval screen (an example is shown in FIG. 4) on a display (S240). Here, when the operator presses the “YES” button on the screen, communication data indicating permission for using that storage 40 is sent from the management computer 80 to the server device 70 through the communication means 90 (S250, S260).

Receiving the communication data, the server device 70 performs path setting of the gateway device 60 so that the storage 40 can be accessed from a predetermined host 35 of the data center 20 managed by the provider which-has made the rental application (S270). The path setting in this case is carried out by a function of the gateway device 60 such as zoning or LU masking. After the path setting, the server device 70 transmits to the management computer 80 a notification notifying that the rental has started, and at the same time, registers, in the storage database and corresponding to the ID of the storage, that the storage is being rented (S280).

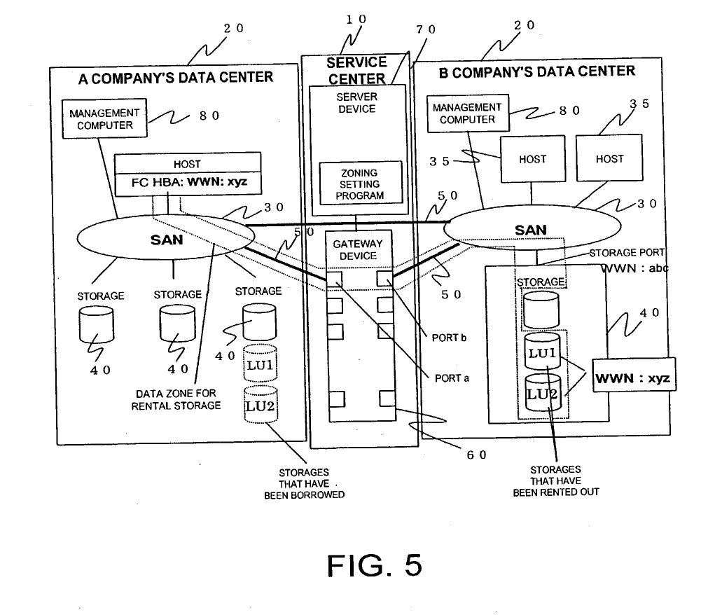

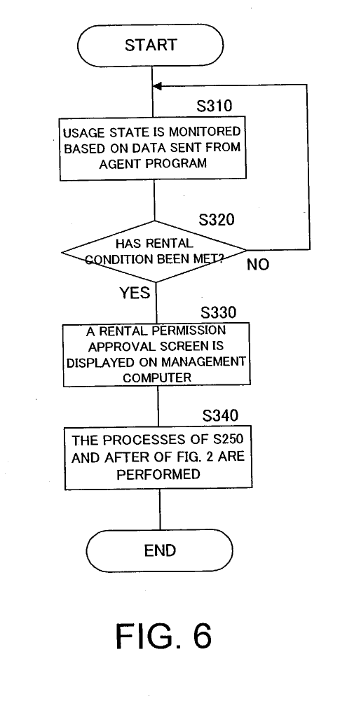

FIG. 5 shows an example of a zoning setting in the above case. The zoning setting is carried out, for example, by allocating to a port “a” of the gateway device 60 a world wide name (WWN) specific to a host bus adapter (HBA) for a Fibre Channel of the host 35 that has been permitted access. Information necessary for this path setting, such as the WWN of each host 35 and each storage 40 which are provided in each data center 20, is stored and managed in the database by the server device 70.

[Automation of Contract Confirmation]

The foregoing rental application method employs a configuration in which the operator monitors the usage state of the storage 40. However, another configuration can be employed in which the operation is automatically carried out by the server device 70. Hereinafter, such an embodiment will be described with reference to a flowchart shown in FIG. 6.

In each host 35, an agent program 38 is operated. The agent program 38 has a function of sending, to the server device 70 at a proper timing, an ID of the storages 40 to be monitored and communication data indicating the usage state (e.g., remaining capacity) of each storage 40, the usage state being obtained by real-time monitoring of states of the storages 40 (remaining capacity and the like) through an IP network or communication means (not shown) based on protocols such as simple network management protocol (SNMP) or SCSI.

The server device 70 stores and manages, in a database in accordance with each storage ID, the usage state of the storages 40 described in the communication data sent at a proper timing from the agent program 38, and gets hold of a real-time usage state of the storages 40, such as the remaining capacity, provided in each data center 20 (S310).

In the server device 70, a rental condition database is operated. In this database, a rental condition of each storage 40 is registered corresponding to the storage ID given to each storage 40. A rental condition may be such that, for example, rental is started if a storage capacity of a predetermined size or more is not used for a predetermined period of time. The rental condition is usually set by the provider. The provider can operate the management computer 80 to register the rental condition in the database, or can have the service trader register the rental condition by informing the service trader the rental condition with telephone, FAX, mail or the like.

The server device 70 compares at a proper timing, such as at regular intervals, a real-time usage state of the storage 40 sent from the agent program 38 with the rental start condition registered in the rental condition database (S320). If the usage state meets the rental start condition, the server device 70 transmits the aforementioned rental approval application screen (S330). The processes that take place after this, in other words, the processes from predetermined path setting of the gateway 60 until the rental start of the storage 40 is similar to that of the foregoing case (process of S250 and after in FIG. 2), and so description thereof will be omitted.

[Cancellation Process]

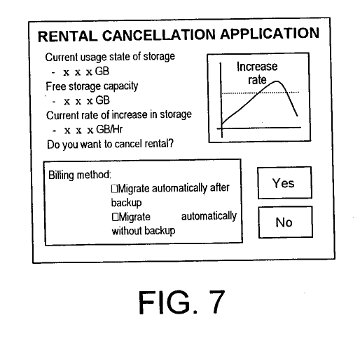

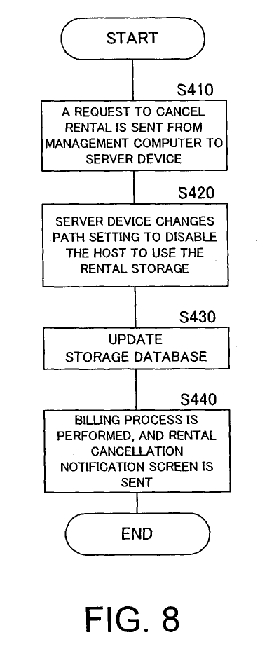

Cancellation of a rented storage is carried out by an operator of a data center through a rental cancellation application screen (such as that shown in FIG. 7) displayed on a management computer 80. If there are a plurality of rented storages, a screen that lists all of the rented storages may be displayed before displaying the screen of FIG. 7. The operator selects a storage from the list, and then the screen of FIG. 7 is displayed. Hereinafter, the process of rental cancellation will be described in detail with reference to a flowchart of FIG. 8.

On the rental cancellation application screen, the usage state, the remaining capacity, a change in usage capacity and the like of a storage 40 are also displayed. If there is a request for a backup of data or transfer of data to another storage, such as a newly introduced storage, on cancellation, the request can be designated through the screen. To carry out cancellation, the operator of a data center 20 presses the “YES” button on the screen. Accordingly, the management computer 80 transmits to the server device 70 the ID of the provider and communication data indicating the request for cancellation and the ID of the storage 40 to be cancelled (S410).

Receiving the communication data, the server device 70 changes the path setting of the gateway device 60 so that the provider can no longer use the storage 40 (S420). Then, taking the provider ID and the storage ID indicated in the received communication data as keys, the server device 70 performs a search through the storage database and deletes the registration indicating that the storage under that ID is being rented (S430).

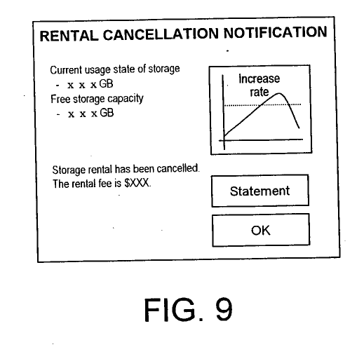

After the completion of the above process, the server device 70 transmits a rental cancellation notification screen, such as the screen shown in FIG. 9, that shows rental fees or the like calculated in accordance with the billing method that is stored and managed to each management computer 80 of the borrower data center 20 that borrowed the storage and the lender data center 20 that rented out the storage (S440).

As a method for billing the rental fees, for example, it is possible to perform billing in accordance with information on specifications of the rented storage, a usage capacity of a rented storage area, usage time, or other such information that has been comprehended by the server device 70 or an agent program 38. As another method, it is possible to calculate the usage fees in a manner that the server device 70 monitors an amount of data flowing through the gateway device 60 and/or the elapsed time from when the path setting of the gateway device 60 was changed, and the amount of data and/or the elapsed time are used as parameters. In the latter case, for example, by using the ID of the transmitter and the ID of the receiver that are described in the data passing through the gateway device 60, the parameters can be monitored and comprehended for each storage 40, each provider and each data center.

On the screen of FIG. 7, if instructions to back-up data have been given, upon cancellation of the rental contract, the data in a rented storage area is backed up off-line to a backup medium, and then deleted from the rented storage area. If instructions to transfer data have been given, the service trader transfers the backed-up data to another storage 40 on-line or by taking the backup medium to a data center 20 that has the storage 40.

Further, the server device 70 can estimate a change in the remaining capacity of the storage 40 that may occur in the future, notify such estimation to the management computers 80, and carry out rental application automatically based on the estimation. This can be done, for example, by storing in the database a history of a usage state sent from an agent program 38, and using this history, for example, to apply an approximate expression for the change over time in the remaining capacity in the past.

Further, there may be a situation in which the storages 40 can be shared among the plurality of data centers 20 by using the service according to the above-mentioned embodiments and also methods other than the service described above. In this case, by configuring the communication means between the data centers 20 used in the aforementioned service independent of communication means used in the other method, it becomes possible to easily obtain information about the amount of data or the like necessary for the billing process in the aforementioned service.

The storage 40 may be a component of a network attached storage (NAS).

As described above, according to the storage system operating method of the present invention, a storage operator managing a data center or the like can perform storage operation efficiently.

Although the preferred embodiment of the present invention has been described in detail, it should be understood that various changes, substitutions and alterations can be made therein without departing from spirit and scope of the inventions as defined by the appended claims.

What is claimed is:

1. A method for operating a storage system including a plurality of storage networks, a gateway device to which said storage networks are connected, and a server device connected to said gateway device,
the method comprising:
providing a management computer that is connected to said server device and that is for getting hold of a usage state of storages connected to the respective storage networks; and
changing a path setting of said gateway device in accordance with information notified from said management computer.

2. A method for operating a storage system according to claim 1, wherein
said management computer transmits to said server device a rental request requesting to borrow a storage area in accordance with said usage state, and
said server device responds to said rental request and changes said path setting of said gateway device to enable a host computer connected to one of said storage networks provided with said management computer to use a storage area provided by a storage connected to another storage network.

3. A method for operating a storage system according to claim 2, wherein
said server device stores and manages a specification, such as a total capacity and processing performance, of said storages connected to the respective storage networks in a database,
said management computer attaches a specification required of a storage area to be rented to said rental request sent to said server device,
said server device responds to said rental request and retrieves from said database a storage that matches said specification required of the storage area to be rented, which is attached to said rental request, and
said server device changes said path setting of said gateway device to enable the host computer connected to the storage network provided with said management computer to use that storage.

4. A method for operating a storage system according to claim 3, further comprising:
displaying a screen showing information about said storage retrieved from said database; and
displaying a screen for approving/disapproving rental of said storage retrieved from said database.

5. A method for operating a storage system according to claim 2, wherein
when said path setting of said gateway device is changed to enable the host computer connected to one of said storage networks provided with said management computer to use said storage connected to said other storage network, said server device gets hold of an amount of communication data that is exchanged between said host computer and said storage and that passes through said gateway device, and calculates a usage fee for using said storage by using said amount of communication data as a parameter.

6. A method for operating a storage system according to claim 2, wherein
when said path setting of said gateway device is changed to enable the host computer connected to one of said storage networks provided with said management computer to use said storage connected to said other storage network, said server device manages an elapsed time from when said change was made, and calculates a usage fee for using said storage by using said elapsed time as a parameter.

7. A method for operating a storage system according to claim 3, wherein
when said path setting of said gateway device is changed to enable the host computer connected to the storage network provided with said management computer to use that storage, said server device calculates a usage fee in accordance with said specification of that storage.

8. A method for operating a storage system including a plurality of storage networks, a gateway device to which said storage networks are connected, and a server device connected to said gateway device,
the method comprising:
in said storage system, connecting to said server device a host computer connected to said storage networks;
executing an agent program on said host computer to collect a usage state of storages connected to said storage networks;
notifying said usage state collected by said agent program to said server device; and
changing with said server device a path setting of said gateway device in accordance with said notified usage state.
